(19) United States
(12) Patent Application Publication
(10) Pub. No.: US 2009/0254205 A1
(43) Pub. Date: Oct. 8, 2009

(54) SEAMLESS SWITCH BETWEEN LOWER AND HIGHER QUALITY AUDIO STREAMS

(75) Inventors: Sergey Orlov, Waterloo (CA); Al Simonov, Sarov (RU); Alexey Martynov, Sarov (RU); Alexey Protasov, Sarov (RU); Andrei Grichine, Waterloo (CA); Alexey Oraevsky, Waterloo (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: Sound Genetics Inc.

(21) Appl. No.: 11/770,587

(22) Filed: Jun. 28, 2007

Related U.S. Application Data
(60) Provisional application No. 60/806,102, filed on Jun. 28, 2006.

(51) Int. Cl. G06F 17/00

(52) U.S. Cl. 700/94

(57) ABSTRACT

A method of switching seamlessly at a receiving end is provided for converting a lower quality digital signal to a higher quality digital signal by initiating a real-time sound reconstruction and restoration process on the lower quality signal. The conversion occurs without interruption of the signal and without re-opening a connection to the signal provider.

Applicant claims the benefit of U.S. Provisional Application Ser. No. 60/806,102 filed on Jun. 28, 2006

### BACKGROUND OF THE INVENTION

1. Field of the Invention

This invention relates to a method of switching seamlessly between higher and lower quality digital audio signals from a lower quality signal received from a signal provider using a switch at a receiving end to initiate a real-time sound reconstruction and restoration process on the lower quality signal to convert the signal to a higher quality signal.

2. Description of the Prior Art

In order to transmit digital audio via data constrained channels, the data must be compressed. The audio signal is encoded with different bitrates dependent upon the available bandwidth on user and content provider sides, among other factors, which limit the amount of data for such transmissions. The lower the bitrate, the lower the resultant quality of the sound. In order to provide better quality sound, the user is typically offered two or more options to receive sound that represents two different flows of data with the same content: one that contains less data and thus lower quality, and one that contains more data, thus higher quality. In order for the user to switch between lower and higher quality streams, the user is required, each time, to re-open connection with content provider side and re-initiate one stream or another. This causes a substantial silent pause between the streams thus delivering an interrupted and unpleasurable experience to the user, and in addition requires the content provider to store and transmit the same content with different bitrates. It is much less expensive for a content provider to transmit data at a low bitrate as less bandwidth is consumed.

### SUMMARY OF THE INVENTION

The present invention provides a method to seamlessly toggle between higher and lower quality audio without re-opening a new connection and re-initiation of another flow of data between content provider and the listener. The method of the invention may also be used to provide a single streaming solution with multiple sound quality characteristics. A content provider can provide all data at a low bitrate and a user can decide to listen to the data at the low bitrate or a higher bitrate without encountering any silent pause while converting from a lower quality sound to a higher quality sound.

A method of switching seamlessly at a receiving end between higher and lower quality audio signals uses low quality digital signals received from a signal provider. The method comprises receiving a lower quality signal from a signal provider, activating a switch at a receiving end to initiate a real-time sound reconstruction and restoration process on the lower quality signal, the switch converting the lower quality signal to a higher quality signal without interruption of the signal.

A method of switching seamlessly between higher and lower quality digital audio signals uses lower quality signals received from a signal provider, the method comprises receiving a lower quality signal from a signal provider, activating a switch at the receiving end to initiate a real-time sound reconstruction and restoration process on the lower quality signal, thereby converting the lower quality signal to a higher quality signal without interruption of the signal.

### BRIEF DESCRIPTION OF THE DRAWINGS

FIG. 1 is a prior art schematic perspective view of a higher quality audio signal at a provider side being reduced to a lower quality audio signal at a receiving end; and

FIG. 2 is a schematic perspective view of a higher quality audio signal at a provider side being reduced to a lower quality signal transmitted through a channel and restored to a higher quality signal at a receiving end.

### BRIEF DESCRIPTION OF THE INVENTION

The proposed method is based on the use of sound restoration and sound reconstruction technologies that provide sound quality improvement on user's computer, delivering perceptually higher fidelity sound than the original data stream. A system and method for compressing and reconstructing audio files is described in Canadian Patent Application number 2,467,466 filed May 17, 2004 which is incorporated by reference herein. There are other sound restoration and sound reconstruction technologies available and the present invention is not limited to the system and method described in that application.

Typically, a lower quality stream represents limited frequency range, so the high frequency content is removed during the encoding to provide lower bitrate transmission. The proposed method uses a switch that initiates a real-time sound reconstruction and restoration process on the receiving end (listener's computer) after the decoding of incoming data is completed. Thus, almost immediately, the quality of the output data is elevated, delivering a seamless switching experience between better quality and lower quality streams without any interruptions of the incoming data stream. The signal from the signal provider is preferably a digital signal sent over the internet or via satellite. Preferably, the switch is computer software that is loaded on a computer at the receiving end. The audio signal is preferably received on the computer and the switch can be activated (pressed) to switch the signal to a higher quality signal or reactivated or deactivated to switch the signal to a lower quality signal. The signal is received as a lower quality digital signal at a lower bitrate.

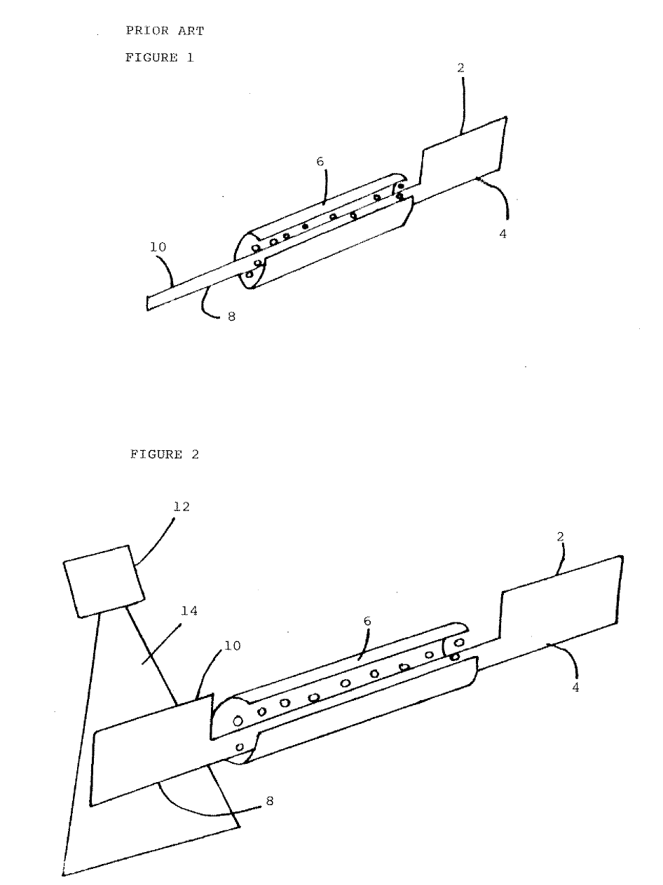

In FIG. 1, a higher quality signal 2 is transmitted from a content provider side 4 through a channel 6 to a receiving end 8. At the receiving end, the signal 2 is a lower quality signal 10. The lower quality signal is represented by a reduced height of the signal and it can be seen that that part of the signal within the channel is also a lower quality signal.

In FIG. 2, the signal 10 at the receiving end 8 has been restored so that the representative height of the signal is the same or greater than the height of the signal 2 at the provider side. The signal 10 has been restored by a real-time sound reconstruction and restoration process depicted generally by a symbol 12 and beam 14.

We claim:

1. A method of the switching seamlessly at a receiving end between higher and lower quality digital audio signals using lower quality digital signals received from a signal provider, said method comprising receiving a lower quality signal from said signal provider, activating a switch at a receiving end to initiate a real-time sound reconstruction and restoration process on said lower quality signal, said switch converting said lower quality signal to a higher quality signal without interruption of said signal.

2. A method as claimed in claim 1 including the step of a converting said higher quality signal to a lower quality signal by reactivating said switch.

3. A method as claimed in claim 1 wherein the signal is music.

4. A method of switching seamlessly between higher and lower quality digital audio signals using lower quality digital signals received from a signal provider, said method comprising receiving a lower quality signal from said signal provider at a receiving end, activating a switch at said receiving end to initiate a real-time sound reconstruction and restoration process on said lower quality signal, thereby converting said lower quality signal to a higher quality signal without interruption of said signal.

5. A method as claimed in claim 4 including the step of transmitting said lower quality signal via a channel.

6. A method as claimed in claim 5 including the step of transmitting said signal to a computer at said receiving end.

7. A method as claimed in claim 6 including the step of transmitting said lower quality signal at low bitrates.

8. A method as claimed in claim 4 including the step of restoring said signal to have a higher fidelity sound than a higher quality digital audio signal at a transmitting end.

9. A method as claimed in claim 7 including the step of converting said higher quality signal at said receiving end back to a lower quality signal without interruption of said signal by deactivating said switch.

10. A method as claimed in claim 5 wherein said audio signal is music.

11. A method as claimed in claim 4 including the step of converting said lower quality signal to said higher quality signal without re-opening a connection to said signal provider.

12. A method of switching seamlessly between higher and lower quality digital audio musical signals using lower quality digital signals received from a signal provider, said method comprising receiving a lower quality signal from said signal provider at a receiving end, activating a switch at said receiving end to initiate a real-time sound reconstruction and restoration process on said lower quality signal, thereby converting said lower quality signal to a higher quality signal without interruption of said signal.
